(19) United States
(12) Patent Application Publication
(10) Pub. No.: US 2023/0224177 A1
(43) Pub. Date: Jul. 13, 2023

(54) METHODS AND SYSTEMS FOR USER ENVIRONMENT CUSTOMIZATION BASED ON NON-FUNGIBLE TOKENS

(71) Applicant: Bold Metrics Inc., San Francisco, CA (US)

(72) Inventors: Morgan LINTON, San Francisco, CA (US); Daina BURNES, San Francisco, CA (US)

(21) Appl. No.: 18/154,528

(22) Filed: Jan. 13, 2023

Related U.S. Application Data
(60) Provisional application No. 63/266,728, filed on Jan. 13, 2022.

(51) Int. Cl. H04L 9/00; H04L 9/32

(52) U.S. Cl. CPC H04L 9/50; H04L 9/3213

(57) ABSTRACT

According to embodiments of the present disclosure, a method is provided. The method includes receiving first body data for a user of a user device. The method further includes determining second body data for the user by using at least the received first body data. The method further includes generating a non-fungible token based on the second body data. The method further includes registering the non-fungible token in a digital asset client on a user device of the user. The method further includes retrieving from the digital asset client an identifier of the non-fungible token. The method further includes transmitting to a receiver system the identifier of the non-fungible token. The method further includes controlling one or more features of a user environment provided by the receiving system. based on the values of the properties of the non-fungible token.

### CROSS REFERENCE TO RELATED APPLICATIONS

This application claims priority to U.S. Provisional Application No. 63/266,728 and filed on Jan. 13, 2022, which is incorporated by reference herein in its entirety.

### TECHNICAL FIELD

The present disclosure relates to non-fungible tokens and distributed ledger-based networks.

### BACKGROUND

Distributed ledger-based networks use a ledger distributed across multiple nodes to record and verify the authenticity of network data. Distributed ledger-based networks rely on distributed, consensus-based verification of network data, as opposed to a single, centralized point of control. Distributed ledger-based networks are often referred to as blockchain technology, of which Bitcoin and Ethereum are two well-known examples. Among other applications, distributed ledger-based networks can be used to record and exchange non-fungible tokens.

### SUMMARY

According to embodiments of the present disclosure, a method is provided. The method includes receiving first body data for a user of a user device. The first body data describes physical characteristics of the user's body. The method further includes determining second body data for the user by using at least the received first body data. The second body data describes physical characteristics of the user's body. The method further includes generating a non-fungible token based on the second body data. The non-fungible token comprises properties corresponding to physical body characteristics. One or more values of the properties of the non-fungible token are set based on the determined second body data. The non-fungible token is recorded on a distributed ledger-based network. The method further includes registering the non-fungible token in a digital asset client on a user device of the user. The digital asset client stores identifiers of one or more digital assets owned by the user. The method further includes retrieving from the digital asset client an identifier of the non-fungible token. The method further includes transmitting to a receiver system the identifier of the non-fungible token. The method further includes controlling one or more features of a user environment provided by the receiving system. The one or more features of the user environment are controlled based on the values of the properties of the non-fungible token.

According to embodiments of the present disclosure, corresponding systems, apparatuses, and machine-readable media are also provided.

### BRIEF DESCRIPTION OF THE DRAWINGS

FIG. 1 is a diagram of a system using a distributed ledger-based network.

FIG. 2 is a diagram of a system using a non-fungible token.

FIG. 3 is a diagram of a non-fungible token containing body data of a user.

FIG. 4 is a flowchart diagram of a process for generating and using a non-fungible token containing body data of a user.

### DETAILED DESCRIPTION

Distributed ledger-based networks, such as the Bitcoin blockchain and Ethereum blockchain, are used to provide a distributed, verifiable database of information. Blockchain technology is used to permanently record records corresponding to a variety of digital assets. While cryptocurrencies are the digital assets most commonly associated with blockchain technology, blockchain technology is also used to record another type of digital asset, non-fungible tokens.

Non-fungible tokens are, like cryptocurrency tokens, digital assets that can be recorded on the ledger of a distributed ledger-based network. The transfer of non-fungible tokens between different entities likewise can be recorded on the ledger of a distributed ledger-based network. Unlike a cryptocurrency token, a non-fungible token is not fungible for other like tokens. That is, a non-fungible token is unique among a set of like non-fungible tokens. Unlike a cryptocurrency token, a non-fungible token can have authenticity of its uniqueness recorded on the blockchain ledger. As a result, non-fungible tokens have beneficial applications in areas other than cryptocurrencies. For example, non-fungible tokens may have value for digital art, where the authenticity of the artwork is verified through a certificate of authenticity on the blockchain ledger.

While practitioners in the technological field tend to focus on this verifiably unique characteristic as the primary benefit non-fungible tokens, the present inventors have observed other characteristics of non-fungible tokens that may make them beneficial in certain applications, allowing improvements in existing technological environments and technological devices, as well as the creation of entirely new types of technology. First, the distributed, accessible nature of the blockchain ledger allows digital assets to be highly portable across platforms. This is further enhanced by digital asset clients, like “wallets” (e.g., MetaMask) that allow a user to easily store, access, and present digital assets from the blockchain ledger. Second, the protocols that exist for creating digital assets on the blockchain ledger (e.g., ERC-20, ERC-721, ERC-1155) allows for highly customized digital assets, including non-fungible tokens. Third, while the data stored in a non-fungible token on the blockchain ledger is typically accessible by any user and thus publicly accessible, the user that owns the non-fungible token can do so anonymously, e.g., through a wallet not publicly associated with the user's personal identifiable information. Further, the non-fungible token itself need not contain any personal identifiable information. Hence, while the non-fungible token is publicly accessible, it can also be owned anonymously. Collectively, these aspects of non-fungible tokens allow them to be used to store personal information anonymously and in a highly portable way. Thus, even if the user has no intention ever exchanging ownership of certain data, a non-fungible token can nonetheless be an advantageous technology to use for the storing, accessing, and sharing that data.

With atypical uses of non-fungible tokens, such as those described above, improvements in existing technological environments and technological devices, as well as the creation of entirely new types of technology are possible, as described further in this disclosure.

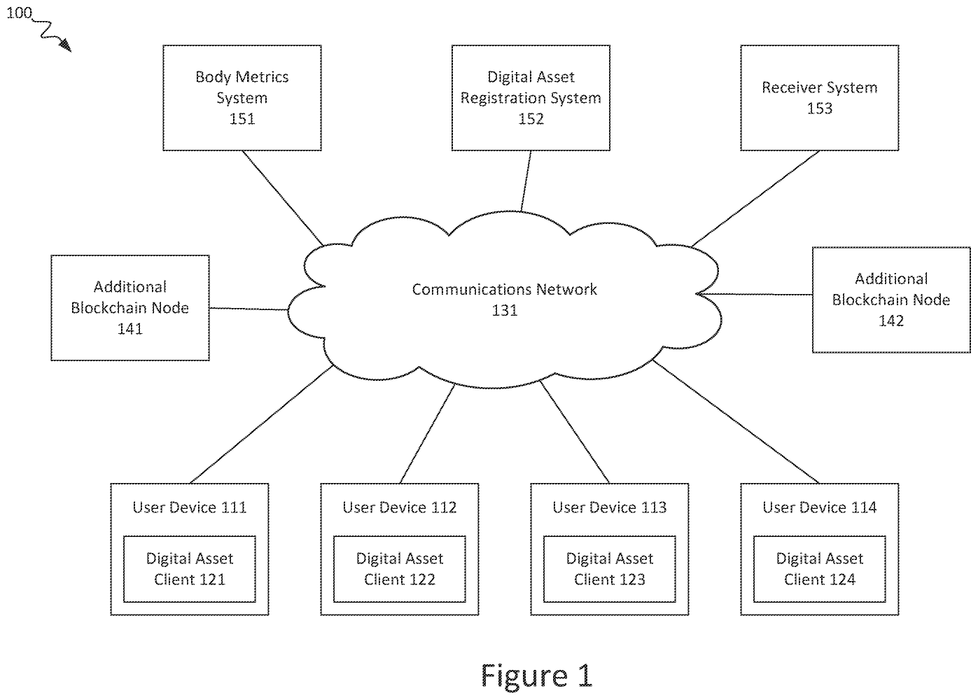

FIG. 1 is a diagram of a system 100 using a distributed ledger-based network according to some embodiments of the present disclosure. The system 100 may include: user devices 111, 112, 113, and 114; digital asset clients 121, 122, 123, and 124; communications network 131; additional blockchain nodes 141 and 142; body metrics systems 151; digital asset registration system 152; and receiver system 153.

The communications network 131 may include any communications network that allows communication between users, devices, or the like. For example, the communication network 131 may be a telecommunications network, such as an IEEE 802.11 Wi-Fi network, a 4G cellular network, a 5G cellular network, a Bluetooth link, a mesh network, other telecommunications network, or some combination of the foregoing.

User devices 111, 112, 113, 114 may include computing devices operated by a user. For example, user devices 111, 112, 113, 114 can include a smartphone, a mobile phone, a tablet computer, a laptop computer, a desktop computer, or other similar devices. The user devices 111, 112, 113, 114 may connect to the communications network 131. Fore example, the user devices 111, 112, 113, 114 may connect to the communications network 131 through a wireless local area network (e.g., IEEE 802.11 WLAN), a cellular connection (e.g., 4G cellular network, 5G cellular network), a short-range communication connection (e.g., a Bluetooth link), other telecommunications technologies, or some combination of the foregoing. The user may use user devices 111, 112, 113, 114 to access other resources that are also connected to the communications network 131, such as the additional blockchain nodes 141 and 142, the body metrics system 151, the digital asset registration system 152, and/or the receiver system 153.

The user devices 111, 112, 113, 114 may include digital asset clients 121, 122, 123, 124.

The digital asset clients may include software and/or hardware modules on the user devices 111, 112, 113, 114 that allow for interaction with a distributed ledger-based network. For example, the digital asset clients 121, 122, 123, 124 may include a “wallet” application (e.g., MetaMask) that allows a user to store information identifying a digital asset that has been recorded on a blockchain ledger. As a further example, the digital asset clients 121, 122, 123, 124 may be a client software program or application that allows a user to generate, register, or mint a non-fungible token. As a further example, the digital asset clients 121, 122, 123, 124 may be a web browser client application that allows a user to access websites associated with the distributed ledger-based network, such as by viewing information on digital assets stored on the blockchain ledger. Other digital asset clients consistent with the present disclosure may be used. More than one digital asset client may be used on any given user device 111, 112, 113, 114.

The additional blockchain nodes 141, 142 may include additional computing devices associated with the blockchain ledger. For example, additional blockchain nodes 141, 142 may include a computing device that stores some or all of the blockchain ledger. For example, the additional blockchain nodes 141, 142 may be servers that store portions of the blockchain ledger for access by the user devices 111, 112, 113, 114, for access by the body metrics system 151, for access by the digital asset registration system 152, for access by the receiver system 153, and/or for access by other blockchain nodes.

The body metrics system 151 may include a system for providing services related to body metrics. For example, the body metrics system 151 may include a software and/or hardware system that uses machine learning and/or artificial intelligence to determine a user's body data based on input body data. As a further example, the body metrics system 151 may include a software and/or hardware system that uses machine learning and/or artificial intelligence to determine items of clothing that may best fit a user based on input body data.

As an example, a user may use user device 111 to access the body metrics system 151. The user may provide body data to the user device 111, such as shoe size, height, weight, and age. The user device 111 may then provide the input body data to the body metrics system 151. Based on the input body data, the body metrics system 151 may determine body data for the user, such as biceps circumference, chest circumference, shoulder width, and hand length. The body metrics system 151 may use machine learning and/or artificial intelligence (e.g., artificial neural networks, classification trees, regression, clustering) to determine the body data. The body metrics system 151 may provide the determined body data to the user device 111. The user device 111 may provide the determined body data to the user.

Some examples of a body metrics system 151 may include the applicant's Virtual Tailor system and/or the applicant's Virtual Sizer system.

The digital asset registration system 152 may include a system for registering digital assets on the blockchain ledger. For example, the digital asset registration system 152 may include a system that mints a non-fungible token on the blockchain ledger, such as the OpenSea system. For example, the digital asset registration system 152 may receive from the body metrics system 151 data defining characteristics of a non-fungible token. The digital asset registration system 152 may generate a non-fungible token and register the non-fungible token on a blockchain ledger. The digital asset registration system 152 may return identification data identifying the registered non-fungible token to the body metrics system 151.

The receiver system 153 may include a system that receives a non-fungible token. The receiver system 153 may customize a user environment based on data stored in the non-fungible token. For example, the receiver system 153 may include one or more of the following: a server or other system providing a website; a server or other system providing a retail clothing website or other retail clothing computing system; a server or other system providing a retail outdoors gear website or other retail outdoors gear computing system; a virtual reality headset or other virtual reality device; a server or other system providing a virtual reality environment; an augmented reality headset or other augmented reality device; a server or other system providing an augmented reality environment; a server or other system providing avatar generation services; a computer-enabled bicycle, computer-enabled treadmill, or other computer-enabled physical fitness device; an automobile; an insurance actuary system or other computing system that determines insurance premiums, insurance coverage, or other insurance policy parameters; a gaming console or other gaming computing system.

As an example, the receiver system 153 may include a retail clothing website server that hosts a retail clothing website. The receiver system 153 may receive a non-fungible token from the user device 111, with the non-fungible token containing body data for the user. Alternatively, the receiver system 153 may receive an identifier associated with the non-fungible token, and the receiver system 153 may retrieve the data defining the non-fungible token from the blockchain ledger (e.g., from additional blockchain node 141). The non-fungible token may have been previously registered by the digital asset registration system 152 and/or the body metrics system 151. Some or all of the body data contained in the non-fungible token may have been previously determined by the body metrics system 151. The receiver system 153 may customize the user environment based on the body data contained in the received non-fungible token. For example, if the receiver system 153 is a retail website server, the receiver system 153 may customize the retail clothing website presented to the user on the user device 111. For example, the receiver system 153 may remove products from the retail clothing website for which the clothing does not fit the user based on the body data contained in the non-fungible token. As further example, the receiver system 153 may remove products from the retail clothing website for which the style of the clothing is determined to not be applicable to the user based on the body data contained in the non-fungible token. As further example, the receiver system 153 may provide special offers and/or discounts to the user based on additional data in the non-fungible token, such as an identifier of a product sponsor of the non-fungible token. Other user environment customizations of a retail clothing website based on data in the non-fungible token are possible in various embodiments.

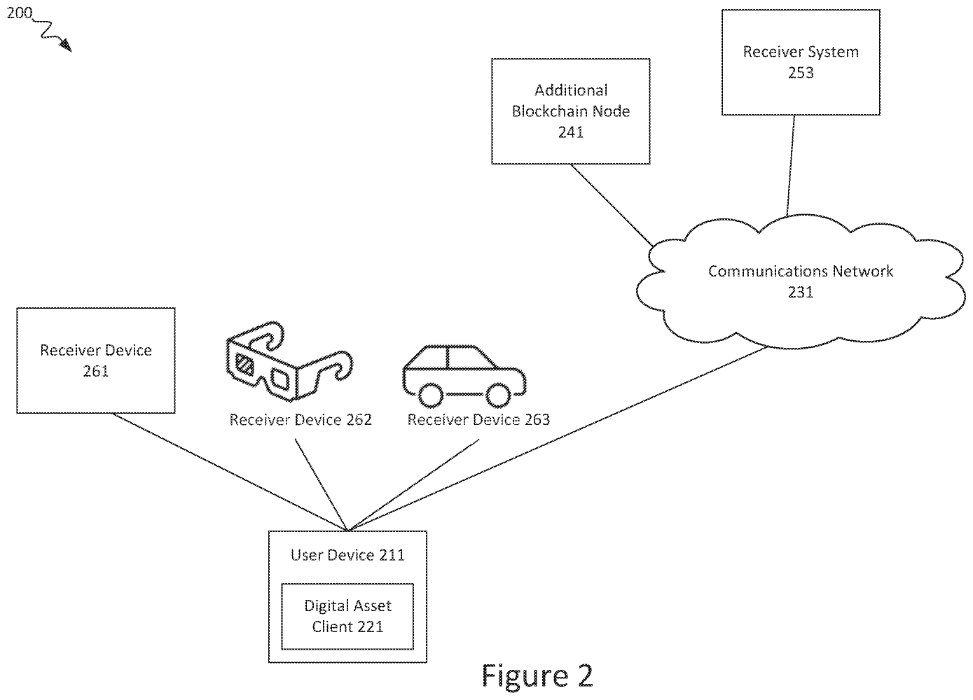

FIG. 2 is a diagram of a system 200 using a non-fungible token according to some embodiments of the present disclosure. The system 200 may include: user device 211; communications network 231; digital asset client 221; receiver devices, 261, 262, and 263; additional blockchain node 241; and receiver system 253.

The system 200 may include elements as further described with respect to system 100. For example, the user device 211 may be provided as described with respect to user devices 111, 112, 113, 114. As further example, the user device 211 may be provided as described with respect to digital asset clients 121, 122, 123, and 124. As further example, the receiver devices 261, 262, 263 may be provided as described with respect to the receiver system 153. As further example, the receiver system 253 may be provided as described with respect to the receiver system 153. As further example, the additional blockchain node 241 may be provided as described with respect to the additional blockchain nodes 141, 142.

The receiver device 261 may include a computer-enabled physical device in the environment of the user. For example, the receiver device 261 may include a computer-enabled bicycle. The receiver device 261 may receive a non-fungible token from the user device 111, with the non-fungible token containing body data for the user. Alternatively, the receiver device 261 may receive an identifier associated with the non-fungible token, and the receiver device 261 may retrieve the data defining the non-fungible token from the blockchain ledger (e.g., from additional blockchain node 241). The non-fungible token may have been previously registered by the digital asset registration system 152 and/or the body metrics system 151. Some or all of the body data contained in the non-fungible token may have been previously determined by the body metrics system 151. The receiver device 261 may customize the user environment based on the body data contained in the received non-fungible token. For example, if the receiver device 261 is a computer-enabled bicycle, the receiver device 261 may customize the user interface of the computer-enabled bicycle. For instance, the receiver device 261 may adjust a physical position of a seat of the computer-enabled bicycle based on the body data in the non-fungible token. The receiver device 261 may adjust a physical position of handlebars of the computer-enabled bicycle based on the body data in the non-fungible token. The receiver device 261 may adjust recommended activities (e.g., workout programs) presented to the user through a screen of the computer-enabled bicycle based on the body data in the non-fungible token. Other user environment customizations of a computer-enabled physical device based on data in the non-fungible token are possible in various embodiments.

The receiver device 262 may include a computer-enabled wearable device in the environment of the user. For example, the receiver device 262 may include a virtual reality headset. The receiver device 262 may receive a non-fungible token from the user device 111, with the non-fungible token containing body data for the user. Alternatively, the receiver device 262 may receive an identifier associated with the non-fungible token, and the receiver device 262 may retrieve the data defining the non-fungible token from the blockchain ledger (e.g., from additional blockchain node 241). The non-fungible token may have been previously registered by the digital asset registration system 152 and/or the body metrics system 151. Some or all of the body data contained in the non-fungible token may have been previously determined by the body metrics system 151. The receiver device 262 may customize the user environment based on the body data contained in the received non-fungible token. For example, if the receiver device 262 is a virtual reality headset, the receiver device 262 may customize the user interface of the virtual reality headset. For instance, the receiver device 262 adjust the appearance of an avatar presented in a virtual reality environment through the virtual reality headset based on the body data in the non-fungible token. For instance, the receiver device 262 may adjust the height, chest dimensions, leg dimensions, and/or arm dimensions of an avatar presented in the virtual reality environment based on the body data in the non-fungible token. For instance, the avatar may be modified to resemble the body characteristics described with the body data in the non-fungible token. The receiver device 262 may remove products from a retail clothing environment presented in the virtual reality environment, for those products for which the clothing does not fit the user based on the body data contained in the non-fungible token. As further example, the receiver device 262 may remove products from a retail clothing environment presented in the virtual reality environment, for those products for which the style of the clothing is determined to not be applicable to the user based on the body data contained in the non-fungible token. As further example, the receiver device 262 may provide special offers and/or discounts to the user based on additional data in the non-fungible token, such as an identifier of a product sponsor of the non-fungible token. Other user environment customizations of a computer-enabled wearable device based on data in the non-fungible token are possible in various embodiments.

The receiver device 263 may include a computer-enabled vehicle in the environment of the user. For example, the receiver device 263 may include a computer-enabled automobile. The receiver device 263 may receive a non-fungible token from the user device 111, with the non-fungible token containing body data for the user. Alternatively, the receiver device 263 may receive an identifier associated with the non-fungible token, and the receiver device 263 may retrieve the data defining the non-fungible token from the blockchain ledger (e.g., from additional blockchain node 241). The non-fungible token may have been previously registered by the digital asset registration system 152 and/or the body metrics system 151. Some or all of the body data contained in the non-fungible token may have been previously determined by the body metrics system 151. The receiver device 263 may customize the user environment based on the body data contained in the received non-fungible token. For example, if the receiver device 263 is a computer-enabled vehicle, the receiver device 263 may customize the user interface of the computer-enabled vehicle. For instance, the receiver device 263 may adjust a physical position of a seat of the computer-enabled vehicle based on the body data in the non-fungible token. The receiver device 263 may adjust a physical position of air vents of the computer-enabled vehicle based on the body data in the non-fungible token. For instance, the receiver device 263 may adjust the vertical and/or horizontal positioning of an air vent so that it is directed at a predetermine body location (e.g., chest) of the user. The vertical and/or horizontal positioning of the air vent may be determined based on the body data in the non-fungible token. The vertical and/or horizontal positioning of the air vent may be determined based on the body data in the non-fungible token and a determination of the user's body position in the vehicle based on the body data in the non-fungible token. The receiver device 263 may adjust a physical position of a display screen of the computer-enabled vehicle based on the body data in the non-fungible token. The receiver device 263 may adjust a physical position of a steering wheel of the computer-enabled vehicle based on the body data in the non-fungible token. Other user environment customizations of a computer-enabled vehicle based on data in the non-fungible token are possible in various embodiments.

In some embodiments, the receiver devices 261, 262, 263 and the receiver system 253 may customize the user environment based on body data in the non-fungible token. For example, the receiver device 262 may be a virtual reality headset. The receiver system 253 may be a server providing a virtual reality environment. The receiver device 262 may receive a non-fungible token from the user device 111, with the non-fungible token containing body data for the user. Alternatively, the receiver device 262 may receive an identifier associated with the non-fungible token, and the receiver device 262 may retrieve the data defining the non-fungible token from the blockchain ledger (e.g., from additional blockchain node 241). The non-fungible token may have been previously registered by the digital asset registration system 152 and/or the body metrics system 151. Some or all of the body data contained in the non-fungible token may have been previously determined by the body metrics system 151. The receiver device 262 and the receiver system 253 may customize the user environment based on the body data contained in the received non-fungible token. For example, the receiver device 262 may provide the received non-fungible token and/or an identifier of the non-fungible token and/or body data contained in the non-fungible token to the receiver system 253. The receiver system 253 may customize the user interface of the virtual reality environment present to the user through the virtual reality headset. For instance, the receiver system 253 may adjust the appearance of an avatar presented in a virtual reality environment through the virtual reality headset based on the body data in the non-fungible token. For instance, the receiver system 253 may adjust the height, chest dimensions, leg dimensions, and/or arm dimensions of an avatar presented in the virtual reality environment based on the body data in the non-fungible token. For instance, the avatar may be modified to resemble the body characteristics described with the body data in the non-fungible token. The receiver system 253 may remove products from a retail clothing environment presented in the virtual reality environment, for those products for which the clothing does not fit the user based on the body data contained in the non-fungible token. As further example, the receiver system 253 may remove products from a retail clothing environment presented in the virtual reality environment, for those products for which the style of the clothing is determined to not be applicable to the user based on the body data contained in the non-fungible token. As further example, the receiver system 253 may provide special offers and/or discounts to the user based on additional data in the non-fungible token, such as an identifier of a product sponsor of the non-fungible token. Other user environment customizations by both a receiver device and a receiver system based on data in the non-fungible token are possible in various embodiments.

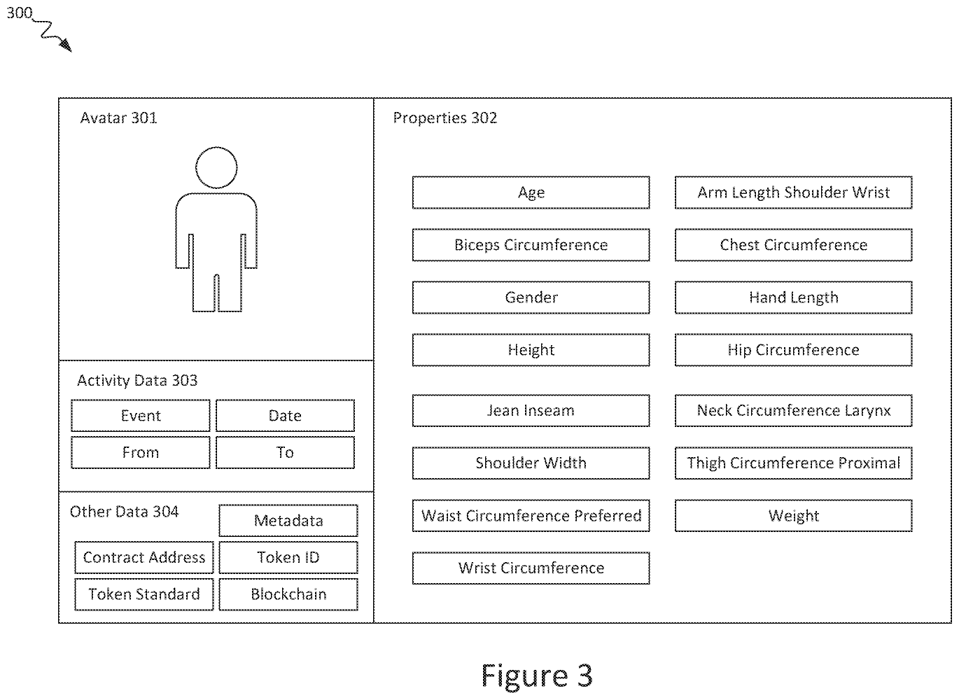

FIG. 3 is a diagram of a non-fungible token 300 containing body data of a user according to some embodiments of the present disclosure. The non-fungible token 300 may be used in a distributed ledger-based network, such as the system 100 and system 200 described elsewhere in this disclosure. The non-fungible token 300 may include: avatar 301; properties 302; activity data 303; and other data 304.

The avatar 301 may include a visual representation of a user. For example, the avatar 301 may include a visual representation of a human with body characteristics corresponding to the body data stored in the non-fungible token 300. For instance, the avatar 301 may be presented in two-dimensional format, in three-dimensional format, or some other representation. In some embodiments, the avatar 301 may be omitted from the non-fungible token 300. In some embodiments, a user may select whether to include the avatar 301 in the non-fungible token 300. For instance, a user may provide a selection of whether to include the avatar 301 prior to the body metrics system 151 and/or digital asset registration system 152 generating, registering, or minting the non-fungible token 300 on the blockchain ledger.

The properties 302 may include body data of a user. For example, the properties 302 may include body data for a user that owns the non-fungible token 300. As further example, the properties 302 may include body data for a person that is not the owner of the non-fungible token 300. As further example, the properties 302 may include body data for the same person that is represented by the avatar 301 o the non-fungible token 300.

In some embodiments, the properties 302 may include one or more of the following body data: age; arm length shoulder to wrist; biceps circumference; chest circumference; gender; hand length; height; hip circumference; jean inseam; neck circumference larynx; shoulder width; thigh circumference proximal; waist circumference preferred; weight; wrist circumference; hip circumference; and/or shoe size. Other body data are possible in various embodiments.

In some embodiments, some of the properties 302 may be omitted from the non-fungible token 300. For example, in some embodiments, the waist circumference preferred may be omitted from the properties 302. As further example, in some embodiments, other body data may be omitted from the properties 302.

In some embodiments, the properties 302 included in the non-fungible token 300 may be determined based on a user selection. For example, in some embodiments, a user may select whether to include one or more of properties 302 in the non-fungible token 300. For instance, a user may provide a selection of whether to include one or more of the properties 302 prior to the body metrics system 151 and/or digital asset registration system 152 generating, registering, or minting the non-fungible token 300 on the blockchain ledger.

In some embodiments, the properties 302 included in the non-fungible token 300 may be determined based on a selection of the body metrics system 151. For example, in some embodiments, the body metrics system 151 may select whether to include one or more of properties 302 in the non-fungible token 300. For instance, the body metrics system 151 may provide a selection of whether to include one or more of the properties 302 prior to the body metrics system 151 and/or digital asset registration system 152 generating, registering, or minting the non-fungible token 300 on the blockchain ledger.

In some embodiments, one or more of the properties 302 may be modifiable even after generating, registering, or minting of the non-fungible token 300. For example, in some embodiments, one or more of the properties 302 may be modified by the user after the original generating, registering, or minting of the non-fungible token 300. As further example, in some embodiments, one or more of the properties 302 may be modified by the body metrics system 151 after the original generating, registering, or minting of the non-fungible token 300. As further example, in some embodiments, one or more of the properties 302 may be modified by the receiver systems 153, 253 after the original generating, registering, or minting of the non-fungible token 300. As further example, in some embodiments, one or more of the properties 302 may be modified by the receiver devices 261, 262, 263 after the original generating, registering, or minting of the non-fungible token 300. For instance, if receiver device 261 is a computer-enabled scale, then the receiver device 261 may modify the weight body data of properties 302 when the user uses the computer-enabled scale. In some embodiments, when one or more of the properties 302 are modified, that modification may be reflected in activity data 303.

In some embodiments, one or more of the properties 302 may be determined by a method other than user input. For example, in some embodiments, one or more of the properties 302 may be determined by the body metrics system 151. As further example, in some embodiments, one or more of the properties 302 may be determined by a prediction of a machine learning algorithm and/or an artificial intelligence algorithm. As further example, in some embodiments, one or more of the properties 302 may be determined by use of a body scanner. As further example, in some embodiments, one or more of the properties 302 may be determined by a computer-enabled measuring tool (e.g., smart measuring tape). As further example, in some embodiments, one or more of the properties 302 may be determined by a phone scanner. As further example, in some embodiments, one or more of the properties 302 may be determined by measurements from a tailor. Other sources of body data are possible in various embodiments.

In some embodiments, one or more of the properties 302 may be determined by a body metrics system. For example, in some embodiments, the shoulder width body data of properties 302 may be determined by body metrics system 151. For instance, the body metrics system 151 may receive input body data, such as age, weight, gender, and height. The body metrics system 151 may determine further body data based on the input body data. For instance, the body metrics system 151 may determine the shoulder width and chest circumference based on the input body data. The body metrics system 151 may provide one or more of the input body data and one or more of the determined body data to the digital asset registration system 152 for generating, registering, or minting of the non-fungible token 300 on the blockchain ledger.

The activity data 303 may include data describing activity performed with respect to the non-fungible token 300. For example, the activity data 303 may include a list of transactions for the non-fungible token 300. For instance, the activity data 303 may identify the original generation, registration, or minting of the non-fungible token 300. The activity data 303 may identify transfers of the non-fungible token 300 between different persons, owners, and/or accounts.

In some embodiments, the activity data 303 may include one or more of the following: an event name; an event description; an event identifier; a date of the event; a time of the event; a timestamp of the event; the identify of a person, owner, and/or account from which the non-fungible token 300 was transferred; the identify of a person, owner, and/or account to which the non-fungible token 300 was transferred; and/or any other activity data for the non-fungible token 300.

The other data 304 may include data describing other information for the non-fungible token 300. For example, the other data 303 may identify the contract address for the non-fungible token 300. The contract address may be an identifier on the blockchain ledger where data identifying and/or authenticating the non-fungible token may be found. As further example, the other data 303 may identify a token ID for the non-fungible token 300. The token ID may be an identifier that uniquely identifies the non-fungible token 300. For instance, the token ID may be an identifier that is unique to the non-fungible token as compared to other non-fungible tokens generated, registered, or minted on the blockchain ledger. As further example, the other data 303 may identify a token standard for the non-fungible token 300. The token standard may be an identifier that identifies a token standard protocol for the blockchain ledger that was used to generate, register, or mint the non-fungible token 300. For instance, the token standard may identify that the ERC-1155 token standard was used to generate, register, or mint the non-fungible token 300. As further example, the other data 303 may identify a blockchain for the non-fungible token 300. The blockchain may be an identifier that identifies a distributed ledger-based network that was used to generate, register, or mint the non-fungible token 300. For instance, the blockchain identifier may identify the Ethereum blockchain as the blockchain for the non-fungible token 300. As further example, the other data 303 may identify metadata characteristics for the non-fungible token 300. The metadata characteristics may be an identifier that identifies whether or not the metadata and/or properties of the non-fungible token 300 are editable.

In some embodiments, the non-fungible token 300 may be generated, registered, or minted according to a protocol defined for the blockchain ledger. For example, the non-fungible token 300 may be generated, registered, or minted according to a protocol defined for one or more of the following distributed ledger-based networks: Ethereum; Bitcoin; Solana; Cardano. As a further example, the non-fungible token 300 may be generated, registered, or minted according to a level 2 technology built on a distributed ledger-based network (e.g., Stacks built on the Bitcoin blockchain). As further example, the non-fungible token 300 may be generated, registered, or minted according to a token standard for the Ethereum blockchain. For instance, the non-fungible token may be generated, registered, or minted according to the ERC-721 token standard. The non-fungible token may be generated, registered, or minted according to the ERC-1155 token standard. The non-fungible token may be generated, registered, or minted according to the ERC-20 token standard.

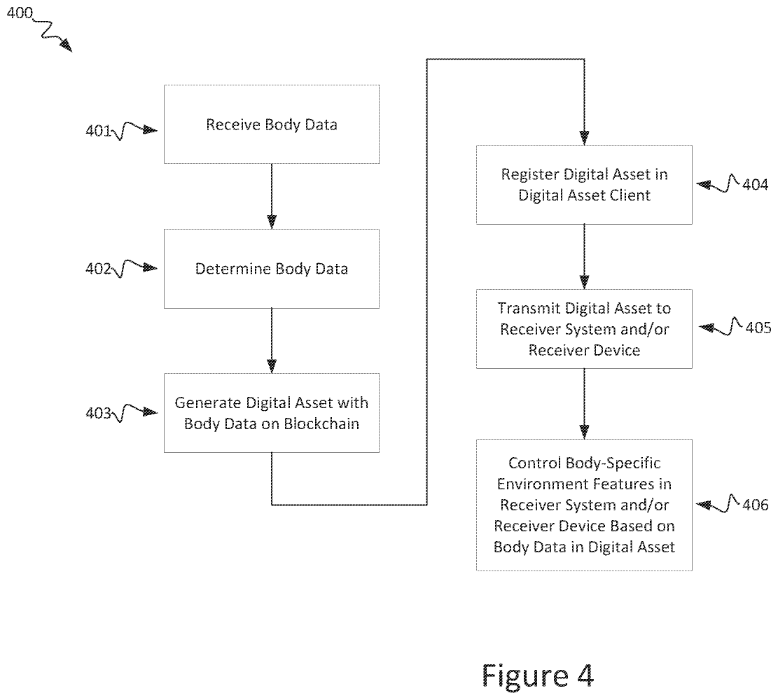

FIG. 4 is a flowchart diagram of a process 400 for generating and using a non-fungible token containing body data of a user according to some embodiments of the present disclosure. In some embodiments, the process 400 may be performed with a distributed ledger-based network, such as with systems 100 and 200. The process 400 may be performed with a non-fungible token, such as non-fungible token 300.

At block 401, body data is received. For example, a user device (e.g., user device 111) may receive body data provided by a user. As further example, a body metrics system (e.g., body metrics system 151) may receive body data provided by a user and/or by a user device (e.g., user device 111).

At block 402, body data is determined. For example, a system (e.g., body metrics system 151) may determine body data based on the body data received at block 401. For instance, a system (e.g., body metrics system 151) may use a machine learning prediction algorithm to predict some body data for a user for whom other body data was received at block 401.

At block 403, a digital asset with body data is generated on a blockchain. For example, a non-fungible token (e.g., non-fungible token 300) is generated, registered, or minted with body data (e.g., properties 302) on a blockchain (e.g., Ethereum). In some embodiments, the digital asset may be a non-fungible token generated, registered, or minted according to a token standard (e.g., ERC-1155, ERC-721).

At block 404, the digital asset is registered in a digital asset client. For example, a non-fungible token (e.g., non-fungible token 300) generated, registered, or minted at block 403 may be stored in a wallet application (e.g., digital asset client 121) on a user device (e.g., user device 111) that belongs to the user. For instance, the user about whom body data was received at block 401 and about whom body data was determined at block 402 may own a user device (e.g., user device 111) that contains a digital asset client (e.g., digital asset client 121) in which the non-fungible token (e.g., non-fungible token 300) that was generated, registered, or minted at block 403 is stored.

At block 405, the digital asset is transmitted to a receiver system and/or receiver device. For example, the non-fungible token (e.g., non-fungible token 300) registered in the digital asset client (e.g., digital asset client 121) at block 404 may be transmitted to a receiver system (e.g., receiver system 153) and/or a receiver device (e.g., receiver device 262). For example, the user's user device (e.g., user device 111) may provide the non-fungible token (e.g., non-fungible token 300) to a website hosted by a web server (e.g., receiver system 153). As further example, the user's user device (e.g., user device 111) may provide the non-fungible token (e.g., non-fungible token 300) to a virtual reality headset (e.g., receiver device 262).

At block 406, body-specific environment features in the receiver system and/or receiver device are controlled based on the body data in the digital asset. For example, a retail clothing website hosted by a web server (e.g., receiver system 153) may modify the clothing presented on a webpage provided to the user via a user device (e.g., user device 111) based on the body data (e.g., properties 302) contained in the received non-fungible token (e.g., non-fungible token 300). As further example, a virtual reality headset (e.g., receiver device 262) may modify an avatar presented to the user based on the body data (e.g., properties 302) contained in the received non-fungible token (e.g., non-fungible token 300).

The process 400 may be modified in various embodiments. For example, one or more blocks of process 400 may be omitted (e.g., block 404, block 405, and/or block 406). As further example, one or more additional blocks may be added to process 400. For instance, after block 403, the non-fungible token (e.g., non-fungible token 300) may first be transmitted to a body metrics system (e.g., body metrics system 151) prior to block 404. As further example, one or more blocks may be modified in process 400. For instance, in block 405, an identifier of the non-fungible token (e.g., non-fungible token 300) may be transmitted to the receiver system (e.g., receiver system 153). The receiver system (e.g., receiver system 153) may then access the body data (e.g., properties 302) of the non-fungible token (e.g., non-fungible token 300) by accessing the blockchain ledger (e.g., with additional blockchain nodes 141, 142).

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method comprising:
receiving first body data for a user of a user device, the first body data describing physical characteristics of the user's body,
determining second body data for the user by using at least the received first body data, the second body data describing physical characteristics of the user's body,
generating a non-fungible token based on the second body data, wherein the non-fungible token comprises properties corresponding to physical body characteristics, wherein one or more values of the properties of the non-fungible token are set based on the determined second body data, and wherein the non-fungible token is recorded on a distributed ledger-based network,
registering the non-fungible token in a digital asset client on the user device of the user, wherein the digital asset client stores identifiers of one or more digital assets owned by the user,
retrieving from the digital asset client an identifier of the non-fungible token,
transmitting to a receiver system the identifier of the non-fungible token,
controlling one or more features of a user environment provided by the receiving system, wherein the one or more features of the user environment are controlled based on the values of the properties of the non-fungible token.

2. The method of claim 1, wherein the first body data includes height and weight.

3. The method of claim 2, wherein the first body data includes age.

4. The method of claim 3, wherein the first body data includes shoe size.

5. The method of claim 4, wherein the second body data includes one or more of bicep circumference, chest circumference, shoulder width, and hand length.

6. A system comprising:
a user device capable of receiving first body data for a user of the user device, the first body data describing physical characteristics of the user's body,
a body metrics system capable of determining second body data for the user by using at least the received first body data, the second body data describing physical characteristics of the user's body, the body metrics system further capable of generating a non-fungible token based on the second body data, wherein the non-fungible token comprises properties corresponding to physical body characteristics, wherein one or more values of the properties of the non-fungible token are set based on the determined second body data, and wherein the non-fungible token is recorded on a distributed ledger-based network,
a digital asset registration system capable of registering the non-fungible token in a digital asset client on the user device of the user, wherein the digital asset client stores identifiers of one or more digital assets owned by the user, wherein the user device is capable of retrieving from the digital asset client an identifier of the non-fungible token, wherein the user device is capable of transmitting to a receiver system the identifier of the non-fungible token,
the receiver system capable of controlling one or more features of a user environment provided by the receiving system, wherein the one or more features of the user environment are controlled based on the values of the properties of the non-fungible token.

7. The system of claim 6, wherein the first body data includes height and weight.

8. The method of claim 7, wherein the first body data includes age.

9. The method of claim 8, wherein the first body data includes shoe size.

10. The method of claim 9, wherein the second body data includes one or more of bicep circumference, chest circumference, shoulder width, and hand length.
